(19) United States
(12) Patent Application Publication
(10) Pub. No.: US 2026/0227129 A1
(43) Pub. Date: Aug. 6, 2026

(54) OPTIMIZED CONDUCTION OF HEAT IN A PLANT FOR THE THERMAL TREATMENT OF MINERAL SUBSTANCES

(71) Applicants: thyssenkrupp Polysius GmbH, Beckum (DE); thyssenkrupp AG, Essen (DE)

(72) Inventor: Eike WILLMS, Dortmund (DE)

(73) Assignees: thyssenkrupp Polysius GmbH, Beckum (DE); thyssenkrupp AG, Essen (DE)

(21) Appl. No.: 19/155,529

(22) PCT Filed: Jan. 30, 2024
(86) PCT No.: PCT/EP2024/052126

§ 371 Date: Aug. 11, 2025

(30) Foreign Application Priority Data
Feb. 14, 2023 (DE) 10 2023 103 471.5
Feb. 14, 2023 (LU) LU103071

(51) Int. Cl. F27B 7/20; C04B 7/43; F27B 7/42; F27D 17/18; F27D 19/00

(52) U.S. Cl. CPC F27B 7/2033; C04B 7/434; F27B 7/42; F27D 17/18; F27D 19/00; F27D 2019/0021

(57) ABSTRACT

A plant for thermal treatment of a mineral material comprises a preheater, a calciner and a kiln, wherein the plant comprises a gas inlet and a gas outlet and a material inlet and a material outlet, wherein the constituents are connected for transferral of a material stream from the material inlet to the material outlet via the preheater, the calciner and the kiln, wherein the constituents are connected for transferral of a gas stream from the gas inlet to the gas outlet via the kiln, the calciner and the preheater, wherein the preheater is a multi-stage preheater, wherein the calciner is connected to a heat exchange apparatus for transferral of the material stream exiting the calciner or the preheater is connected to a heat exchange apparatus for transferral of the material stream exiting a stage of the preheater, wherein the heat exchange apparatus is connected to the preheater for recycling of the material stream.

The present invention is directed to increasing the heat removal from a burning process in order especially to avoid further firings and thus for example and especially to allow complete utilization of the offgas purification of the main process.

Cement plants are complex systems. Their complexity is currently increasing, for example in order to make the plants more environmentally friendly. Substitute fuels for example are thus being employed in order especially to save on fossil resources. Apparatuses are also being integrated to separate the generated and released carbon dioxide and thus avoid release of this greenhouse gas. However, this requires energy. At the same time for example clays are being employed and calcined to minimize carbon dioxide release from the input but these clays require regular drying. For many processes it is therefore attempted to utilize energy from the main process, for example with intensive use of heat exchangers in the context of the gases exiting the process. However the amount of heat made available thereby is limited. At the same time a further combustion unit would increase complexity especially with respect to a carbon dioxide separation.

DE 10 2018 206 673 A1 discloses oxyfuel clinker production with a special means of oxygen injection.

DE 10 2018 206 674 A1 discloses oxyfuel clinker production without recirculation of the preheater offgases.

DE 10 2014 010 044 B3 discloses a process for waste heat utilization in a plant for cement production as well as a plant for cement production.

DE 195 18 926 A1 discloses a process and an apparatus for producing burnt material.

U.S. Pat. No. 4,071,309 A discloses a process and apparatus for producing cement comprising a preheater, a kiln and a heat exchanger for heating the combustion air.

There is therefore a desire to provide thermal energy in as integrated a manner as possible.

It is an object of the invention to provide sufficient thermal energy from the actual main process for all upstream, downstream or parallel processes.

This object is achieved by the plant having the features specified in claim 1. Advantageous developments will be apparent from the subclaims, the description that follows and the drawings.

The plant according to the invention is used for thermal treatment of a mineral material. The plant is especially a plant for producing cement clinker. The plant comprises a preheater, a calciner and a kiln. The plant comprises a gas inlet and a gas outlet and also a material inlet and a material outlet. The constituents (preheater, calciner and kiln) are connected for transferral of a material stream from the material inlet to the material outlet via the preheater, the calciner and the kiln. The constituents are further connected for transferral of a gas stream from the gas inlet to the gas outlet via the kiln, the calciner and the preheater. The plant thus in principle has a countercurrent construction, wherein the streams can however locally flow cocurrently in places, for example in the calciner. The preheater is a multi-stage preheater. This represents a typical thermal treatment apparatus for production of cement clinker for example which has been reduced to its most important basic components and is well known from the prior art in a wide variety of manifestations. The plant typically also comprises a material cooler which is typically arranged between the kiln and the gas inlet and in which the product is cooled and the gas supplied to the kiln is heated. The material cooler may also be configured such that only a partial gas stream is transferred to the kiln, a further portion of the material cooler is cooled with another gas stream (typically the cooler region) and the gas stream thus heated is used at another location, for example in a drying apparatus. The plant may for example also be configured for oxyfuel operation, i.e. (ideally) pure oxygen is initially used and converted by combustion processes into (ideally) ultimately pure carbon dioxide (plus water which is easily separable) (further carbon dioxide is usually additionally released from the mineral material). This (ideally) pure carbon dioxide may then be otherwise used, thus avoiding its emission, without costly gas separation. One of the challenges in the oxyfuel process is that of avoiding secondary air, especially nitrogen from the ambient air, as a result of which all possible gas leakage sites must correspondingly be sealed to the greatest possible extent. The secondary air amount may be for example 5% to 10% over the entire process. Any reduction in the secondary air thus directly results in increased purity of the carbon dioxide and thus reduces the cost of the necessary purification. It is therefore critical if there is ingress of ambient air and thus nitrogen into the gas stream, while escape of gas into the environment is irrelevant at least having regard to the aspect of the necessary purification. While the invention is particularly suitable for the oxyfuel process it is not limited thereto.

According to the invention the calciner is connected to a heat exchange apparatus for transferral of the material stream exiting the calciner or the preheater is connected to a heat exchange apparatus for transferral of the material stream exiting a stage of the preheater. The heat exchange apparatus is connected to the preheater for recycling of the material stream. The process thus discharges a warm solid stream and no gas stream according to the invention. This has a number of advantages. Firstly the discharging of a solid material stream is easy to secure against ingress of secondary air and is therefore especially suitable for the oxyfuel process. This also makes it possible very easily to also effect relatively large scale discharge from the process in relatively simple fashion. The energy required therefor may be provided in simple fashion in the main process, as a result of which especially all additional measures (use of substitute fuels, offgas purification, carbon dioxide separation and the like) may be fully utilized and need not be reserved multiple times as would be the case if a further combustion apparatus for producing heat were present at another location. This also makes it possible to easily ensure the required temperature and residence time for reliable combustion particularly when using substitute fuels. The heat exchange apparatus is thus especially used to avoid further heat generation apparatuses, especially combustion apparatuses, in the overall complex. Further advantages are set out below.

In a further embodiment of the invention the heat exchange apparatus is a cocurrent heat exchanger comprising a cyclone separator or a fluidized bed heat exchanger. Both variants have advantages, especially depending on how the heat is to be transferred. A cocurrent heat exchanger comprising a cyclone separator enables extremely rapid heat transfer through direct contact between the gas and the solid material transported by the gas stream. Suitable gases especially include air or else a recirculated process gas. By contrast, a fluidized bed heat exchanger comprises typically tubular conduits for a heat transfer medium arranged in a fluidized bed. In this case heat transfer is effected through a wall, thus making the process markedly slower. On the other hand, a separation between the material and the heat transfer medium is achieved so that heat transfer oils in particular and steam especially are suitable. Very high steam temperatures are especially also achievable, thus in turn increasing efficiency for example in a turbine for driving a compressor or a generator. The fluidized bed heat exchanger is preferably fluidized with a small amount of fluidization gas, wherein the fluidization gas is preferably recirculated. This makes it possible to reliably rule out introduction of secondary air into the plant, for example.

In a further embodiment of the invention the heat exchange apparatus is connected to a milling apparatus or a drying apparatus. The heat exchange apparatus in this case is a cocurrent heat exchanger comprising a cyclone separator in which a gas stream is heated which is then in turn passed into the milling apparatus in a heated state. In this case the connection between the heat exchange apparatus and the milling apparatus or the drying apparatus is a gas conduit for this heated gas.

In a further embodiment of the invention the gas outlet of the plant is connected to a carbon dioxide separation apparatus. The cement industry in particular is a carbon dioxide-intensive industry. Separation therefore has a very great effect. There are already several available alternative processes for carbon dioxide separation from an offgas stream. Two of these include for example amine scrubbing and the carbonate looping process (also calcium looping process). However, the temperatures required for the carbonate looping process are markedly higher. In both cases the carbon dioxide from the offgas stream is initially chemically bound, in one case to an amine and in the other case to CaO. This occurs in the part of the carbon dioxide separation apparatus known as the absorber. The medium laden with carbon dioxide is then transferred into another region of the carbon dioxide separation apparatus and regenerated there, i.e. the carbon dioxide is released again. As a result, the carbon dioxide stream is free from nitrogen or argon for example. Regeneration typically requires energy. By way of example and preferably the carbon dioxide separation apparatus is an amine scrubber. The amine scrubber comprises an amine regeneration apparatus in which the carbon dioxide bound to the amine is released again. The amine regeneration apparatus is connected to the heat exchange apparatus for transferral of the medium heated in the heat exchange apparatus. The heat exchange apparatus may be for example in the form of a fluidized bed heat exchanger for generating steam.

In a further embodiment of the invention the first stage of the preheater adjacent to the calciner is connected to the heat exchange apparatus for transferral of the exiting material stream from the first stage of the preheater. In the present case adjacent is to be understood as meaning that the material stream/the gas stream is in each case passed from one adjacent component to the other adjacent component, in the present case the material stream from the first stage of the preheater adjacent to the calciner into the calciner and the gas stream from the calciner into the first stage of the preheater adjacent to the calciner. The heat exchange apparatus is connected to the second stage of the preheater for recycling of the material stream. The second stage is the stage downstream of the first stage in the material flow direction and upstream of the first stage in the gas flow direction. This has proven to be the ideal temperature window to obtain for example high quality steam for efficient further utilization.

In a further embodiment of the invention the plant is configured for operation with a gas comprising less than 50% by volume, preferably less than 10% by volume, of nitrogen in the gas stream supplied to the gas inlet. It is accordingly an oxyfuel plant that is concerned here. The aim here is to avoid ideally all secondary air or air otherwise entering the system in order to obtain the purest possible carbon dioxide at the end of the process. The process according to the invention makes this possible through the discharging only of the solid mineral material.

In a further embodiment of the invention the heat exchange apparatus has ambient air as the heat transfer medium. The heat transfer medium air is brought into direct contact with the material stream. This results in a particular advantage when the plant is connected to a carbon dioxide separation apparatus and/or is operated according to the oxyfuel process. In both cases the carbon dioxide from the main process does not enter the environment. However, contact of the ambient air which contains carbon dioxide, if only in small amounts, with the hot, at least partially decarbonated, material causes the decarbonated material to reabsorb carbon dioxide (particularly optimally around 650° C.). This carbon dioxide is re-released in the calciner at the latest and is thus separated with the further carbon dioxide and not released into the atmosphere. The emission of new carbon dioxide is thus not only prevented but carbon dioxide is also removed from the atmosphere (if only to a small extent) and then separated together with the carbon dioxide from the kiln process and subsequently sequestered. The cost of this is minimal, and so the costs and energy input are minimal compared to conventional CO2 separation and subsequent sequestration.

In a further embodiment of the invention the kiln and/or the calciner comprise a substitute fuel feeding apparatus. Substitute fuels must be combusted at a minimum temperature and for a minimum duration (as also required by law). This is readily achievable in the main process. For small firing plants, for example in a drying apparatus, where substantially lower temperatures are required, this would be uneconomic. However, the utilization of the heat exchange apparatus according to the invention thus makes it possible to provide the required heat in the simplest fashion using substitute fuels.

In a further embodiment of the invention the heat exchange apparatus is connected to a turbine. The turbine is connected to a carbon dioxide compressor. During separation of carbon dioxide, for example by the oxyfuel process or by separation in an amine scrubber, the carbon dioxide is compressed. This step is relatively energy intensive in the process. The turbine could alternatively be connected to a generator for power generation in order for example to make the plant independent of an external power grid.

In a further embodiment of the invention the heat exchange apparatus is a two-stage apparatus. The first heat exchange stage is configured for transferral of the heat from the material stream to a gas stream. The second heat exchange stage is configured for indirect transferral of the heat from the gas stream heated in the first heat exchange stage to a steam stream. The second heat exchange stage may therefore be configured as a plate heat exchanger for example or as a shell and tube heat exchanger. It is preferable when the gas is recirculated between the first heat exchange stage and the second heat exchange stage.

In a further embodiment of the invention the plant comprises a further heat exchange apparatus. For example a first heat exchange apparatus is arranged between the first stage of the preheater and the second stage of the preheater and a second heat exchange apparatus is arranged between the second stage of the preheater and the third stage of the preheater. The first heat exchange apparatus and the second heat exchange apparatus may therefore be used independently of one another, for example to provide heat for two different processes. However, these may alternatively be connected in series for the heat exchange medium. For example steam is initially heated in the second heat exchange apparatus and then further heated in the first heat exchange apparatus. This makes it possible to altogether achieve a higher temperature level for the steam and thus a higher efficiency.

In a further embodiment of the invention the heat exchange apparatus comprises a cold material feed. A cold solid is supplied to the heat exchange apparatus via the cold material feed. The material stream and the cold material stream which is supplied via the cold material feed are mixed in the heat exchange apparatus. In the heat exchange apparatus the two solid streams, hot and cold are directly mixed, thus allowing the heat to be directly transferred. The heat exchange apparatus is connected to the preheater for recycling of the material stream via the material inlet. Especially and preferably the combined gas stream (hot and cold) is collectively reintroduced at the start of the process. A drying of the cold material stream is effected for example and preferably by heating the cold material stream. Said material stream is for example heated to 90° C. and thus dried through the mixing in the heat exchange apparatus. The escaping moisture is preferably dissipated and removed via the gas phase. The cold material feed may be used for example to add finely divided material, for example raw meal, lime, fly ash, slag, waste sand and/or residues from concrete demolition, for example crushed sand or cement stone.

In a further embodiment of the invention the plant is a plant for producing cement clinker.

In a further embodiment of the invention the plant is operated according to a process wherein the combustion processes are performed exclusively within the plant. That is to say further combustion processes, for example in a dryer or an amine scrubber are eschewed or at least reduced to a great extent. As mentioned above this substantially facilitates offgas purification and especially carbon dioxide separation. It also facilitates the use of substitute fuels for all thermal processes.

In a further embodiment of the invention the amount of heat removed in the heat exchange apparatus is controlled according to the temperature of the gas stream at the gas outlet or a point in the gas stream downstream of the gas outlet. Control may be effected for example by controlling the flow of the heat exchange fluid through the heat exchange apparatus. There are offgas purification processes, for example special dust separators, that must not exceed a certain temperature arranged downstream of the processes. This control makes it possible to easily control the outlet temperature of the gas stream without directly intervening in the main process even in case of temperature variations in the process.

In a further embodiment of the invention the plant is operated with a gas comprising less than 50% by volume, preferably less than 10% by volume, of nitrogen in the gas stream supplied to the gas inlet.

In another embodiment of the invention the heat exchange apparatus uses ambient air as the heat exchange medium. The heat transfer medium air is brought into direct contact with the material stream.

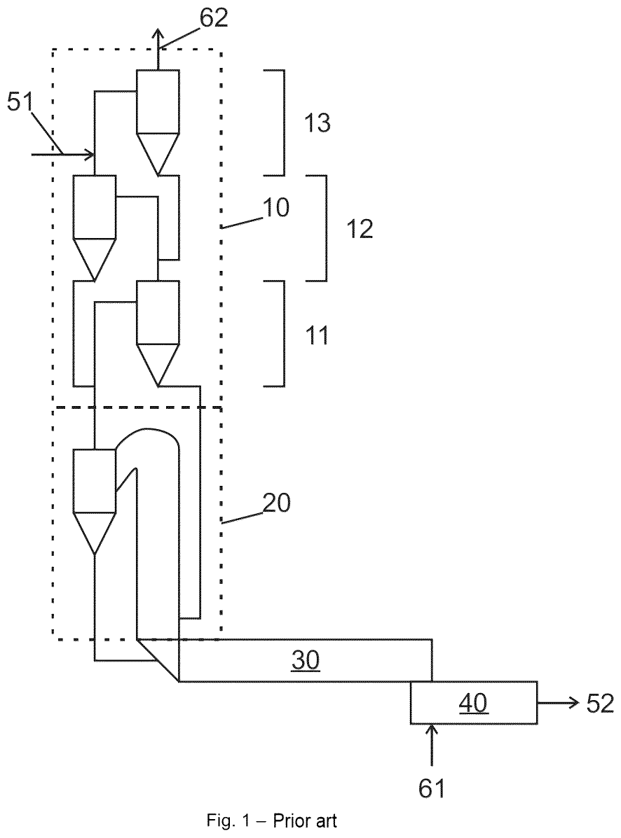

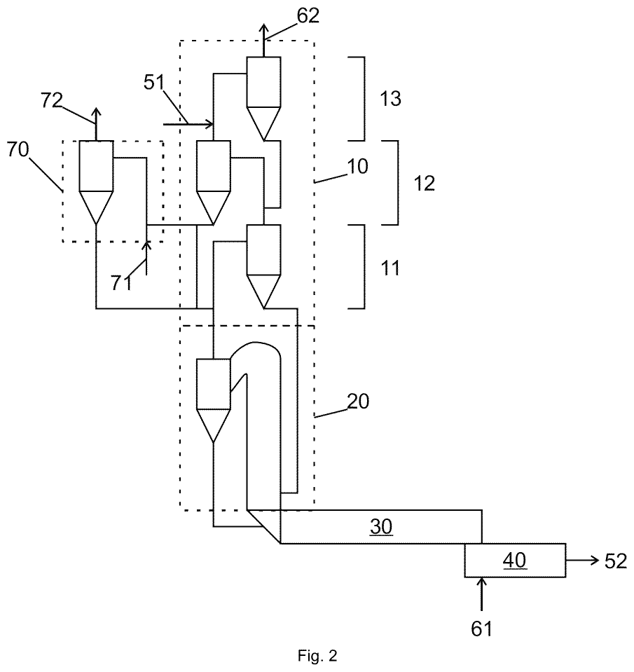

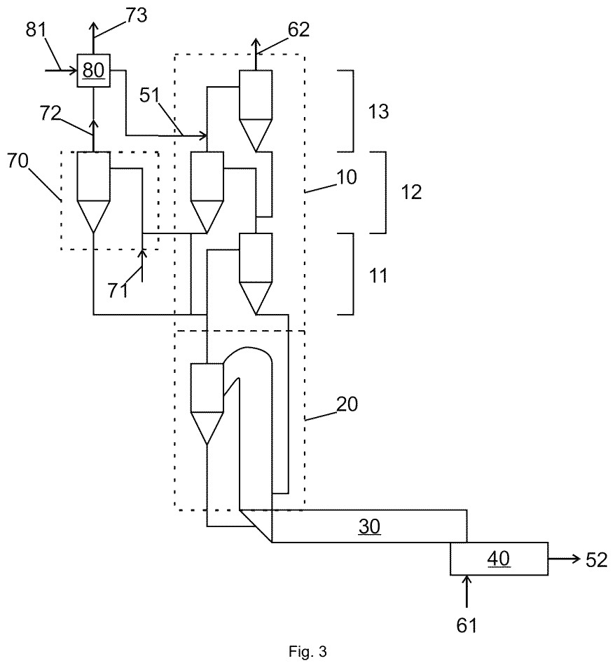

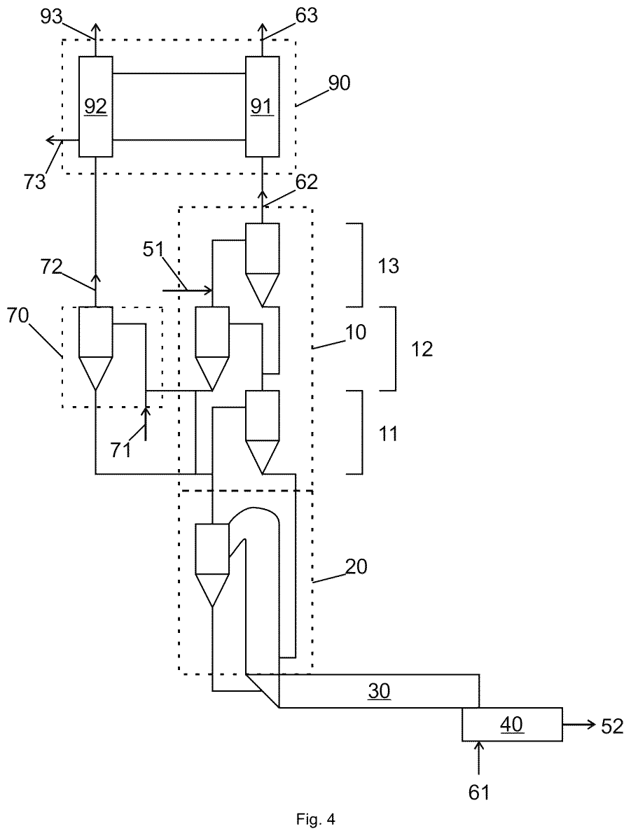

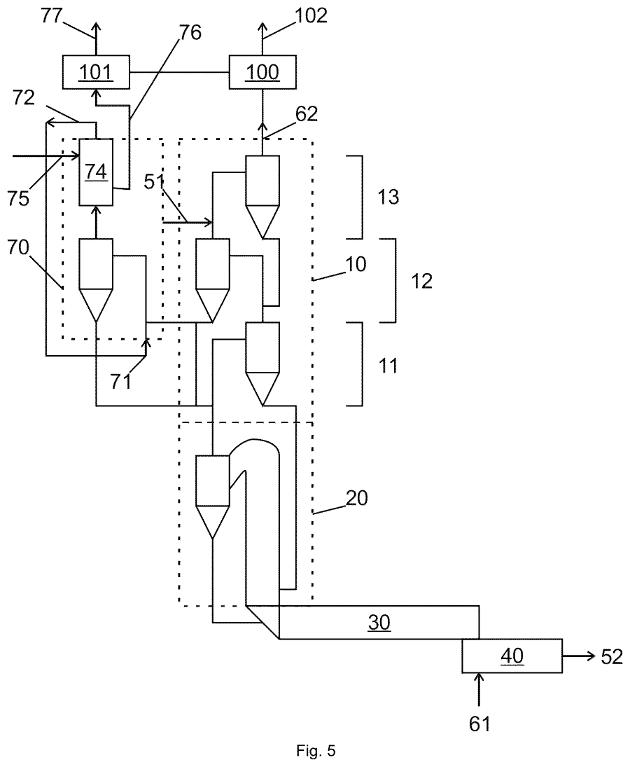

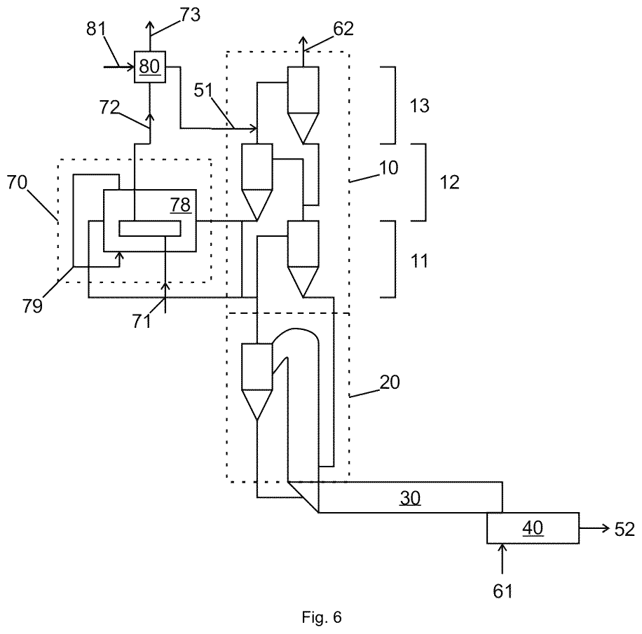

The plant according to the invention is more particularly elucidated hereinbelow with reference to exemplary embodiments depicted in the figures.

| | |
|---|---|
| FIG. 1 | Prior art |
| FIG. 2 | First example |
| FIG. 3 | Second example |
| FIG. 4 | Third example |
| FIG. 5 | Fourth example |
| FIG. 6 | Fifth example |

FIG. 1 initially shows a plant according to the prior art. Material to be thermally treated is introduced into the preheater 10 via the material inlet 51 and subjected to staged preheating in the third stage 13, the second stage 12 and the first stage 11. Stages 11, 12, 13 are configured as cocurrent heat exchangers comprising a cyclone separator. The preheated material is transferred to the calciner 20, then to the kiln 30 and finally to a material cooler 40 and from there to the material outlet 52. The gas stream is overall run in countercurrent to the material stream. The gas is introduced via the gas inlet 61 to the material cooler 40, preheated therein and transferred to the kiln 30. A combustion for heating/energy provision is typically carried out in the kiln 30. The gas is further transferred to the calciner 20 where a further combustion is usually carried out. The gas is transferred from the calciner 20 to the preheater 10 and then to the gas outlet 62.

Also possible here are all further modifications or variations known to those skilled which are customary and known for such plants, for example and especially a gas bypass between the material cooler 40 and the calciner 20. The material cooler 40 may likewise comprise for example a further gas stream, for example in the end region in particular (at a low temperature of the material).

Further to the prior art, FIG. 2 shows a heat exchange apparatus 70 in a first example. The material stream downstream of the cyclone separator of the second stage is partly transferred to the heat exchange apparatus 70. This allows the material to be discharged in simple fashion without secondary air being introduced into the plant during reintroduction. In the example shown the material stream is brought into contact with a medium, for example air, supplied via the medium inlet 71 in a cocurrent heat exchanger and subsequently separated again in a cyclone separator. This allows the heated medium, for example air, to be discharged via the medium outlet 72 and supplied to a further process.

Further to the example shown in FIG. 2 the second example shown in FIG. 3 additionally comprises a milling apparatus 80. The medium heated in the heat exchange apparatus 70 is transferred to the milling apparatus 80. The unmilled material is supplied to the milling apparatus 80 via the milling material inlet 81, is milled therein and is then transferred to the preheater 10 via the material inlet 51. The material may not be directly and immediately transferred but on the contrary may preferably be intermediately stored in a silo. A further mixing, including with further solids, may also be carried out for example. The medium cooled in the milling apparatus 80 is discharged via the cold medium outlet 73 and could be at least partially recycled to the medium inlet 71.

In addition to the example shown in FIG. 2 the third example shown in FIG. 4 comprises a carbon dioxide separation apparatus 90, for example an amine scrubber. The offgas from the plant is transferred from the gas outlet 62 to the carbon dioxide separation apparatus 90, more precisely to the absorber 91. A large proportion, for example 90%, of the carbon dioxide is bound, for example to an amine, in absorber 91. The offgas thus purified is then discharged via offgas outlet 63. The scrubbing system, for example amine, laden with bound carbon dioxide is transferred from the absorber 91 into a regenerator 92 in order therein to re-release the carbon dioxide and thus transfer the scrubbing medium back into the absorber 91. The energy required for the regeneration is supplied by the medium heated in the heat exchange apparatus 70 from the medium outlet 72 of the carbon dioxide separation apparatus 90 and, after release of the necessary energy, released again via the cold medium outlet 73. The medium is typically run in a separate system, for example heat exchange tubes, so that direct contact between the amine and the medium does not occur. This also avoids a subsequent separation of the medium from the amine or carbon dioxide. The medium may be returned to the medium inlet 71 from the cold medium outlet 73. After renewed release of the carbon dioxide this is discharged via the carbon dioxide outlet 93 and may be sent for further use.

FIG. 5 shows a fourth example. In this case the plant is used to operate an oxyfuel process so that the offgas at the gas outlet 62 (after a dehumidification (not shown)) consists to an extremely large extent of carbon dioxide and is therefore passed into a compressor 100 and discharged via a carbon dioxide outlet 102. The compressor 100 is driven by a turbine 101. To drive the turbine 101 the heat exchange apparatus 70 is configured as a two-stage apparatus. In a first heat exchange stage the heat is transferred to a recirculated gas and in the second heat exchange stage 74 to a steam which is supplied via the steam inlet 75 and transferred to the turbine 101 as superheated steam 76. The steam cooled downstream of the turbine 101 is discharged again via the steam outlet 77 and may be recycled to the steam inlet 75.

FIG. 6 shows a fifth example which differs from the second example from FIG. 3 in terms of the type of heat exchange apparatus 70. In the fifth example shown the heat exchange apparatus 70 is a fluidized bed heat exchanger 78 which generates a fluidized layer in its interior via a fluidization air circuit 79. Arranged within the fluidized bed are heat exchange tubes which are supplied with a medium via a medium inlet 71 and this medium in a heated state is sent on to the milling apparatus 80 via the media outlet 72.

Reference numerals

| | |
|---|---|
| 10 | Preheater |
| 11 | First stage |
| 12 | Second stage |
| 12 | Third stage |
| 20 | Calciner |
| 30 | Kiln |
| 40 | Material cooler |
| 51 | Material inlet |
| 52 | Material outlet |
| 61 | Gas inlet |
| 62 | Gas outlet |
| 63 | Offgas outlet |
| 70 | Heat exchange apparatus |
| 71 | Medium inlet |
| 72 | Medium outlet |
| 73 | Cold medium outlet |
| 74 | Second heat exchange stage |
| 75 | Steam inlet |
| 76 | Superheated steam |
| 77 | Vapor outlet |
| 78 | Fluidized bed heat exchanger |
| 79 | Fluidization air circuit |
| 80 | Milling apparatus |
| 81 | Milling material inlet |
| 82 | Cold medium outlet |
| 90 | Carbon dioxide separation apparatus |
| 91 | Absorber |
| 92 | Regenerator |
| 93 | Carbon dioxide outlet |
| 100 | Compressor |
| 101 | Turbine |
| 102 | Carbon dioxide outlet |

1-16. (canceled)

17. A plant for thermal treatment of a mineral material, comprising constituents including:
a preheater;
a calciner;
a kiln;
a gas inlet;
a gas outlet;
a material inlet; and
a material outlet;
wherein the constituents are connected for transferral of a material stream from the material inlet to the material outlet via the preheater, the calciner and the kiln;
wherein the constituents are connected for transferral of a gas stream from the gas inlet to the gas outlet via the kiln, the calciner and the preheater;
wherein the preheater is a multi-stage preheater;
wherein the calciner is connected to a heat exchange apparatus for transferral of the material stream exiting the calciner or the preheater is connected to a heat exchange apparatus for transferral of the material stream exiting a stage of the preheater;
wherein the heat exchange apparatus is connected to the preheater for recycling of the material stream.

18. The plant as claimed in claim 17, wherein the heat exchange apparatus is a cocurrent heat exchanger comprising a cyclone separator or a fluidized bed heat exchanger.

19. The plant as claimed in claim 17, wherein the heat exchange apparatus is connected to a milling apparatus or a drying apparatus.

20. The plant as claimed in claim 17, wherein the gas outlet of the plant is connected to a carbon dioxide separation apparatus.

21. The plant as claimed in claim 20, wherein the carbon dioxide separation apparatus is an amine scrubber, wherein the amine scrubber comprises an amine regeneration apparatus, wherein the amine regeneration apparatus is connected to the heat exchange apparatus for transferral of the medium heated in the heat exchange apparatus.

22. The plant as claimed in claim 17, wherein the first stage of the preheater adjacent to the calciner is connected to the heat exchange apparatus for transferral of the material stream exiting the first stage of the preheater and the heat exchange apparatus is connected to the second stage of the preheater for recycling of the material stream, wherein the second stage is the stage downstream of the first stage in the material flow direction and upstream of the first stage in the gas flow direction.

23. The plant as claimed in claim 17, wherein the kiln and/or the calciner comprise a substitute fuel feeding apparatus.

24. The plant as claimed in claim 17, wherein the heat exchange apparatus is connected to a turbine, wherein the turbine is connected to a carbon dioxide compressor.

25. The plant as claimed in claim 17, wherein the heat exchange apparatus is a two-stage apparatus, wherein the first heat exchange stage is configured for transferral of the heat to a gas stream, wherein the second heat exchange stage is configured for indirect transferral of the heat from the gas stream heated in the first heat exchange stage to a steam stream.

26. The plant as claimed in claim 17, wherein the plant comprises a further heat exchange apparatus.

27. The plant as claimed in claim 17, wherein the heat exchange apparatus comprises a cold material feed, wherein the material stream and the cold material stream which is supplied via the cold material feed are mixed in the heat exchange apparatus, wherein the heat exchange apparatus is connected to the preheater for recycling of the material stream via the material inlet.

28. The plant as claimed in claim 17, wherein the plant is a plant for producing cement clinker.

29. A process for operating a plant according to claim 17, wherein combustion processes are performed exclusively within the plant.

30. The process as claimed in claim 29, wherein the amount of heat removed in the heat exchange apparatus is controlled according to the temperature of the gas stream at the gas outlet or a point in the gas stream downstream of the gas outlet.

31. The process as claimed in claim 29, wherein the plant is operated with a gas comprising less than 50% by volume of nitrogen in the gas stream supplied to the gas inlet.

32. The process as claimed in claim 29, wherein the plant is operated with a gas comprising less than 10% by volume of nitrogen in the gas stream supplied to the gas inlet.

33. The process as claimed in claim 29, wherein the heat exchange apparatus uses ambient air as the heat exchange medium, wherein the heat exchange medium air is brought into direct contact with the material stream.
